(19) United States
(12) Patent Application Publication
(10) Pub. No.: US 2017/0265447 A1
(43) Pub. Date: Sep. 21, 2017

(54) Elevator Baitwell

(71) Applicant: Raul I. Tano, Miami, FL (US)

(72) Inventor: Raul I. Tano, Miami, FL (US)

(21) Appl. No.: 14/948,504

(22) Filed: Nov. 23, 2015

(51) Int. Cl. A01K 97/05; A01K 63/02

(52) U.S. Cl. CPC A01K 97/05; A01K 63/02

(57) ABSTRACT

The present invention comprises a cylindrical baitwell having a circular cross-section with vertical sides attached to a circular bottom producing a water impervious container. Disposed within the cylindrical container is an elevator plate that is perforated to permit the passage of water therethrough but which perforations are too small to allow the passage of any of the live bait. Attached to the perforated elevator plate at two points opposite each other is a handle comprised of two vertical rods and connected at the top with a handle attached to both of those rods. At the top of the container is a lid of s circular configuration with a diameter that matches the diameter of the cylindrical container on which it rests. The lid is perforated by two openings of sufficient diameter to accommodate movement of the vertical rods upward and downward by the use of the handle attached to them. The secular cover also includes a door to open and close which can be used to access the live bait when the elevator plate has been raised to force all of the live bait in the water to nearly the top of the water in the container in which the live bait is immersed. Thus the operator raises the handle with one hand, opens the door with the other hand and reaches into retrieve the live bait after which the handle is released in the secular elevator per perforated plate recedes back to the bottom of the container and the doors closed.

### BACKGROUND OF THE INVENTION

1. Field of the Invention:

The present invention relates to the field of fishing equipment and specifically relates to a live fishing bait container that facilitates retrieval of live bait with a very inexpensive structure of extremely simple design.

2. Description of the Prior Art:

The science of sport fishing has always involved attracting the targeted fish to the means by which is caught. One of the common ways to do that is to use live bait, in the form of a small fish such as a minnow. Live bait buckets can be as simple as water in a bucket. But in order to facilitate the retrieval of live bait various inventions have been patented that supposedly make it easier to retrieve the live bait without spending a lot of time or effort doing so. There have, therefore, been patents issued using nets to scoop up the live bait. See for example U.S. Pat. No. 3,319,372 by Wright for Minnow Bucket and U.S. Pat. No. 3,039,225 by Samelka for Minnow Pail Attachment, but such devices are believed to miss many of the live bait or allow it to escape. Other prior devices are much more complex, such as those involving gating and metering apparatus. See, for example, U.S. Pat. No. 3,834,062 by Nalepha for Minnow Bucket with Movable Means for Grasping and Holding Bait; U.S. Pat. No. 3,380,186, by Donner for Minnow Bucket; U.S. Pat. No. 3,550,307 by Donner for Fresh Bait Holder and U.S. Pat. No. 3,513,584 by Donner for Fishing Bucket. Even more complex devices include aerating means and cooling chambers such as U.S. Pat. No. 3,726,039 by Borrelli for Minnow Pail and U.S. Pat. No. 3,831,310 by Frangullic for Live Bait Bucket. These more complex devices have the disadvantage of being much more expensive to manufacture and more high priced to purchase. Another prior reference is Pat. No. 3,955,306 by Honda for Handy Live bait Bucket, which couples the means to isolate the bait from the water to the means for open the container. This reference assumes that is important to have a covered container that must be operable for both of the foregoing functions, i.e., open the container and delivery of the bait, with only one hand. There is no explanation of what the other hand is doing and why one handed operation is important to the user.

The present invention is the picture of absolute simplicity that renders it very inexpensive to purchase and recognizes that the second hand is not being used when retrieving bait anyway. In the present invention the container is opened and a perforated elevator plate is raised until the bait is readily accessible, a bait fish is retrieved and the elevator plate is allow to return to its resting point at the bottom of the baitwell.

### SUMMARY OF THE INVENTION

Bearing in mind of the foregoing, it is a principal object of the present invention to provide an elevator baitwell of extreme efficiency.

There is another objective of the present invention to provide a baitwell that is extremely effective in not allowing any of the live bait to escape because the elevator covers 100% of the horizontal area of the baitwell in delivering bait to the surface for retrieval by the fisherman.

Another related object of the present invention is to provide a baitwell of such efficiency with extreme simplicity of design.

Another related object of the present invention is to provide all the foregoing with the design that is extremely inexpensive to purchase.

Other objects and advantages will become apparent to those skilled in the art upon reference to the following descriptions and the appended drawings.

In accordance with a principal aspect of the invention there is provided a cylindrical baitwell having a substantially circular cross-section with vertical sides attached to a circular bottom such that a water impervious container results. Disposed within the cylindrical container is an elevator plate that is perforated to permit the passage of water therethrough but which perforations are too small to allow the passage of any of the live bait with only the flow through of water. Attached to the cylindrical perforated elevator plate at two points opposite each other is a handle comprised of two vertical rods at the top of which is a handle attached to both of the those rods. At the top of the cylindrical container is a lid of circular configuration and having a diameter that matches of the cylindrical container on which it rests. The lid is perforated by two openings of sufficient diameter to accommodate movement of the vertical rods uponward and downward by the use of the handle attached to them. The circular cover also includes a door to open and close which can be used to access the live bait when the elevator plate has been raised to force all of the live bait in the water to nearly the top of water in the container in which the live bait is immersed. Thus the operator raises the handle with one hand opens the door with the other hand and reaches in to retrieve the live bait after which the handle is released and the circular elevator perforated plate recedes back to bottom of the container and the door is closed.

### BRIEF DESCRIPTIONS OF THE DRAWINGS

Various of other features of the invention will become apparent to those skilled in the art from the following descriptions taken in conjunction with the appended drawings, in which:

FIG. 1 is a perspective view of the preferred embodiment of the present invention.

FIG. 2 is a perspective drawing of the elevator showing its circular perforated plate and handle.

FIG. 3 is an enlarged broken front view of one of two latch mechanisms to hold the handle in fixed lowered position.

FIG. 4 is an enlarged broken side view of the latch mechanism of FIG. 3

### DETAILED DESCRIPTION OF THE PREFERRED EMBODIMENT

As required, a detailed embodiment of the present invention is disclosed herein; however, is to be understood that the disclosed embodiment is merely exemplary of the invention, which may be embodied in various forms. Therefore, specific structural and functional detailed disclosure herein is not to be interpreted as limiting but merely as a basis for the claims and as a representative basis for teaching one skilled in the art to variously employed the present invention in virtually any purportedly detailed structure.

Reference is now made to the drawings wherein like characteristics to the present invention shown in the various figures are designated by the same reference numerals.

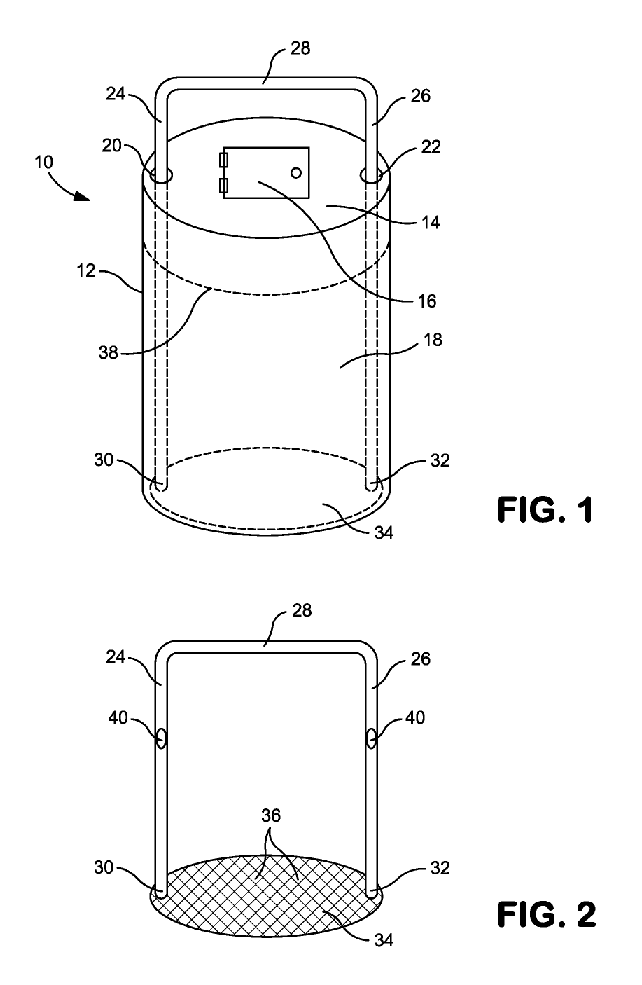

FIG. 1 is a perspective view of the present invention 10 comprised of a cylinder 12 or circular cross section in constant diameter which in impervious to water. The cylinder 12 is covered by a removable top 14 containing a door 16 that can be opened by the user to retrieve live bait disposed in water 18. Disposed between opening 20 and 22 within top 14 are vertical rods 24 and 26. Vertical rods 24 and 26 are joined by handle 28. At the lower ends of vertical rods 24 and 26 are removable connections 30 and 32 through a perforated a elevator plate 34. Elevator plate 34 is just sightly less the inside diameter of cylinder 12 so that when it is raised as an elevator no live bait can pass between circular plate 34 and side walls of cylinder 12. The connections of vertical rods 30 and 32 to elevator plate 34 are detachable so that the elevator can be removed when handle and vertical rods are separated from the elevator plate 34.

FIG. 2 is a perspective view of the elevator apparatus removed from the container 12. It is comprised of handle 28, vertical rods 24 and 26, detachable connections 30 and 32, elevator plate 34, which contains perforations 36, which are too small for live baits to pass through but regularly allow water to pass through as the elevator is raised in the container to force live bait to the top of the water surface 38. (See FIG. 1).

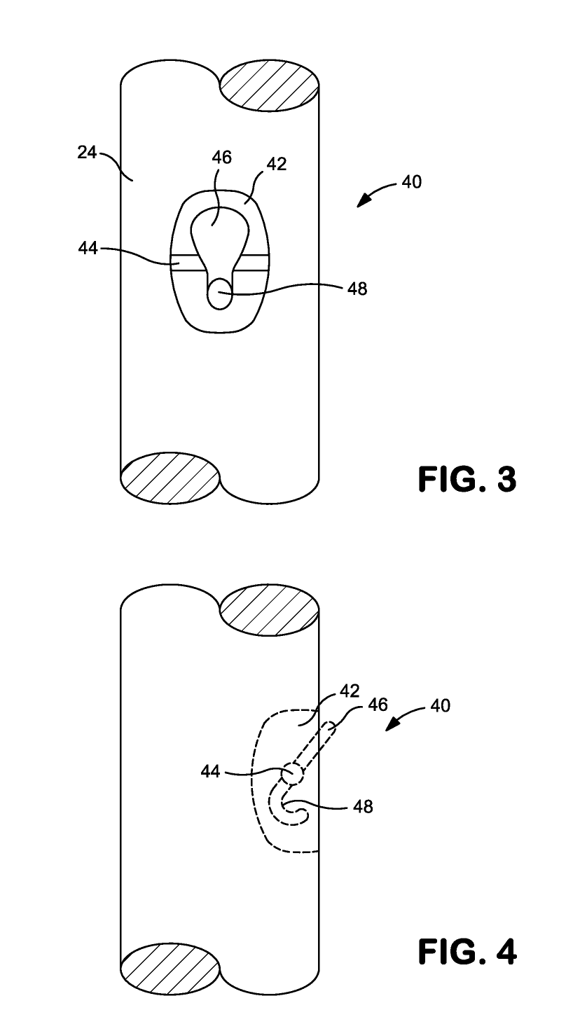

FIG. 3 is an enlarged broken front view of one of two latch mechanisms 40 to hold the handle 28 in a fixed lowered position so that the handle 28 can be used to carry the baitwell 10 from place to place without raising the elevator plate when moving the baitwell 10. The latching mechanism 40 is comprised of a recess 42 in vertical rod 24. The recess 42 contains an axle 44 on which is pivotally mounted push button 46 and hooking means 48. Hooking means 48 latches against the underside of removable top 14 as seen in FIG. 1 so that the handle can not be raised above its lower position. The same device is used also in vertical rod 26 when the baitwell 10 has been placed in its desired position. The removable top 14 can be opened to push the hooking means 48 back in to recess 42 so that the handle can be raised and lowered for bait retrieval.

Turning finally to FIG. 4, recess 42, axle 44, push button 46 and hooking means 48 are seen in phantom.

While the invention has been described, disclosed, illustrated and shown in various terms, or a certain embodiment or modification which it has been assumed in practice, the scope of the invention is not intended to be, nor it should not be deemed to be, limited thereby and such other modifications or embodiments as may be suggested by teaching herein are particularly reserved especially as they fall within the breadth and scope of the claims here appended.

What is claimed is:

1. A baitwell comprising:
a cylindrical water impervious container fixedly attached to a bottom and having a top removably connected to the container;
a door within the top that can be oppened so a user can access live bait disposed in the baitwell;
a perforated elevator plate disposed within the baitwell and having dimensions that fit closely within internal dimensions of the baitwell;
a handle attached to two vertical rods wherein the rods are removably attached to the perforated elevator plate, whereby raising the handle raises the elevator plate near a surface of water disposed in the baitwell.

2. The baitwell of claim 1 in which the vertical rods can be detached from the elevator plate for one of cleaning and other maintenance purposes.

3. The baitwell of claim 1 is which the cylinder of the baitwell comprises a circular cross section.

4. The baitwell of claim 1 is which the handle can be locked in its lowered position by pressing the push buttons in to vertical rods such that the hooking means engage with an underside of the removable lid.

5. The baitwell of claim 1 is which the lid can be raised so that hooking means can be retracted from the underside of the lid to free the elevator plate from the lid so the elevator plate can be raised and lowered at user's will to retrieve live bait.
